(19) United States
(12) Patent Application Publication
(10) Pub. No.: US 2015/0027406 A1
(43) Pub. Date: Jan. 29, 2015

(54) ADJUSTABLE FUEL TRIM MODULE FOR DIESEL ENGINE

(71) Applicants: Douglas A. Cooper, Olathe, KS (US); Corey R. Springer, Overland Park, KS (US)

(72) Inventors: Douglas A. Cooper, Olathe, KS (US); Corey R. Springer, Overland Park, KS (US)

(21) Appl. No.: 14/341,686

(22) Filed: Jul. 25, 2014

Related U.S. Application Data
(60) Provisional application No. 61/858,449, filed on Jul. 25, 2013.

(51) Int. Cl. F02D 41/40; F02D 41/14

(52) U.S. Cl. CPC F02D 41/406; F02D 41/1401
USPC 123/364

(57) ABSTRACT

An adjustment mechanism for allowing fine-tuning the amount of fuel to a Diesel engine by an operator of the engine is provided. A module conveniently within reach of the operator of the engine allows the operator to tune the engine independent of any throttle setting while the engine is operating. In one embodiment for an electronically controlled Diesel engine, an electrical input representative of barometric pressure to an electronic engine controller is modified to be under control of the operator, who can adjust the input independent of the throttle to vary injected quantities of fuel according to the instant conditions under which the engine is operating.

### CROSS REFERENCE TO RELATED APPLICATIONS

This application claims the benefit of provisional application No. 61/858,449, filed Jul. 25, 2013.

### FIELD OF THE INVENTION

This invention relates generally to diesel engines, and particularly to medium speed diesel engines such as found on over-the-road tractor-trailers wherein fine tuning of certain engine parameters may be made during operation of the engine.

### BACKGROUND OF THE INVENTION

To address rising fuel costs, the need for better fuel economy and potentially reduced maintenance of a Diesel engine, Applicant proposes at least one engine control that allows an operator of the vehicle or engine to minimally adjust the amount of injected fuel until the engine is “happy”, i.e. operating without producing smoke, is “crisp” in throttle response and the exhaust gas temperature is within normal parameters. As the operator of the engine is best suited to make these determinations based on his familiarity with the engine or engines, the engine control of the instant invention is located for convenient adjustment by the operator. Used and adjusted properly, such control will optimize the fuel mileage and performance of the engine.

In a diesel engine, liquid fuel oil is injected as a fine mist into a cylinder wherein induction air is compressed by a piston to develop a temperature, typically around 900 degrees F., which is higher than the ignition temperature of the fuel, in order to ignite the fuel. As such, the fuel is broken up into droplets, or atomized, the droplets at least partially evaporating and mixing with the compressed air in the cylinders to form a flammable air/fuel mixture. However, and in contrast to a gasoline, alcohol or other similarly fueled engine, the air/fuel mixture in a Diesel engine is not critical. In a gasoline engine, the optimum air/fuel mixture is a stoichiometric mixture of 14.7 parts air to 1 part fuel wherein quantities of fuel and air are precisely calculated so that all the fuel is completely burned and all the oxygen in the air is used in burning the fuel, without an excess of either in the exhaust gasses. On the other hand, a Diesel engine, when idling, can easily operate at a 60 to 1 air/fuel ratio, and at full power may typically operate with a air/fuel ratio of 14 to 15 to 1. In other words, the power a Diesel engine develops is determined by the amount of injected fuel into an environment of excess oxygen so that all the fuel is burned, while the power developed by a gasoline engine is determined by the quantity of a precise fuel/air mixture. However, and critical to Applicants invention, is the notion that the injected fuel quantity of a Diesel engine must be precisely matched with the load for optimum fuel economy, prevention of pollution and optimum operation of the engine. Here, where the injected fuel quantity precisely matches the load, the combustion chambers are hotter, with a subsequently higher pressure, than when an excess of fuel is present because the excess of fuel condition for a given load cools the combustion temperatures and reduces power the engine can provide. This means that more power can be extracted from the engine when the injected fuel is precisely matched to actual loading of the pistons. In one example, Applicants have found that, in one particular truck engine that uses one gallon of fuel an hour at idle, the fuel control system of the instant invention surprisingly reduces fuel consumption by 40%, so that the same truck engine at idle consumes 0.6 gallons an hour. In other instances, fuel economy during several tests have shown that fuel economy can be improved by at least 20%.

In any case, both gasoline and diesel engines are designed to operate based on air having an oxygen content of 21% at sea level. While this may have been true in the past, it is not true today, particularly in large cities such as Los Angles, San Francisco, Mexico City, Beijing and other cities where the oxygen content of air has been found to be depleted to as little as around 12% -15% or so. In such places, the oxygen content of air at a barometric pressure equivalent to sea level, or 14.7 PSI, has the same oxygen content as an altitude of around 8,000 to 14,000 feet above sea level. As such, and for a given barometric pressure, such as the typical 14.7 PSI found at sea level, and for a loaded truck or a truck going uphill or both, the injected fuel quantity may be greater than what the available content of oxygen in the inducted air can burn, or greater than the loading on the pistons. In such an oxygen-depleted environment, this can cause emission of additional pollutants being produced due to unburned hydrocarbons, carbon monoxide and particulates in the exhaust gasses, in addition to reducing fuel economy, as noted above.

Another factor relating to optimum operation of a Diesel engine is that each diesel engine of the same design and manufactured by the same manufacturer may be slightly different due to manufacturing differences and imperfections. Here, each like engine may require slightly different injected fuel quantities for a given throttle setting in order to operate optimally. In yet other situations, the composition of available fuel may vary from one fuel source to the next, requiring a slightly different amount of fuel to be injected in order to optimally match engine loading with quantity of injected fuel.

The fuel injection timing and quantity of fuel injected are typically parameters set by the engine manufacturer, and cannot be changed except by a skilled mechanic. In older, mechanically controlled fuel injected engines, a centrifugal device adjusts fuel injection timing similarly to the timing advance in a gasoline engine. As such, engine timing is varied from injection at top dead center for an engine under load, to a few degrees after top dead center for a partially loaded or unloaded engine. On these older engines, mechanical adjustments on the fuel pump on the engine in the engine compartment determine timing and quantity of injected fuel. In newer engines operated by a computer, there is typically a fuel map in the computer that, in conjunction with sensors that provide RPM, exhaust gas temperature, boost pressure and the amount of inducted air, which infers the amount of oxygen, determines timing and sets the quantity of injected fuel for a given load and barometric pressure. However, such a computerized engine control system typically does not provide optimal operation for a variety of reasons, as noted above. Engine manufacturers realize this, and set fuel injection quantities so that the engine burns slightly richer than necessary.

Undesirable engine exhaust emissions, including carbon monoxide (“CO”), particulate matters (“PM”) and smoke, are generated when there is too much injected fuel to be completely burned by the available oxygen in a cylinder, and when loading on the pistons does not match the quantity of injected fuel, as noted above. Also, when engines are operated at higher altitudes, i.e., at a lower barometric pressure, less oxygen is available, causing the air-fuel mixture to become richer, which as noted decreases engine performance, lowers fuel economy and increases exhaust emissions of CO, PM, and smoke. While altitude compensators are fitted to some Diesel engines used in vehicles, they are imprecise, and in some instances are merely a preset device or connection, such as a jumper plug or wire, and used only over 10,000 feet, so that the quantity of injected fuel is slightly more by a set amount for under 10,000 feet altitude or slightly less by a set amount over 10,000 feet altitude.

Accordingly, it would be desirable to allow precision operator control over at least quantity of injected fuel in a diesel engine, particularly in a vehicle such as an over-the-road truck and separate from operation of the throttle, in order to fine tune and optimize engine operation, performance and fuel economy.

### BRIEF DESCRIPTION OF THE DRAWINGS

FIG. 1 is a block diagram of engine controller circuitry for a Diesel engine.

FIG. 2 is a partially schematic, partially block diagram of the instant invention

### DETAILED DESCRIPTION OF THE DRAWINGS

The Invention is a remotely operated device fitted to a Diesel engine that can be conveniently operated manually during operation of the engine, typically from the cab of a truck, semi tractor, farm tractor or the like, and which permits manual, operator controlled changes, independent of the throttle, in at least quantity of fuel injected into the cylinders for any given throttle and load situation. Such a device may also have predetermined settings determined for each individual engine that are easily changed by the operator, such as at least one setting for an unloaded truck and a second setting for a loaded truck. Since commercial trucks are routinely weighed and the weight of the load is known, incremental settings may also be provided, for example for each 1,000 lbs, each 3000 lbs, each 5,000 lbs or 10,000 lbs of load, which may depend on the truck and engine size and extent to which it is anticipated that the truck is to be loaded. Where incremental settings are provided, the number of increments corresponding to loading may also depend on the resolution of the desired adjustments. Such incremental adjustments may be indicated to an operator by “clicking” detent positions on a control knob or lever that click from one position to the next when the knob is turned, with each position representing an increment of loading: With such a knob, many detent positions, such as 70 or more, or a few, such as 5-10, may be obtained. Such a knob, when used in a truck cab, is resistant to “creep” due to vibration.

For older trucks or tractors where the quantity of injected fuel is controlled mechanically, a simple cable such as a bicycle or motorcycle brake cable arrangement may extend from the cab to an adjustment on the fuel pump that determines quantity of injected fuel in order to adjust the fuel/air mixture for any given throttle position. In the cab, the cable would be attached to a pulley or similar arrangement operated by a knob or lever such that when the knob or lever is moved through a range of positions, would operate the cable to slightly adjust the fuel mixture leaner or richer depending on operator preferences or engine operating conditions. Levers, bellcranks, gears or the like may be used so as to reduce movement at the adjustment so that a relatively large movement of a knob or lever in the operator's cab will effect a smaller movement at the adjustment on the fuel pump.

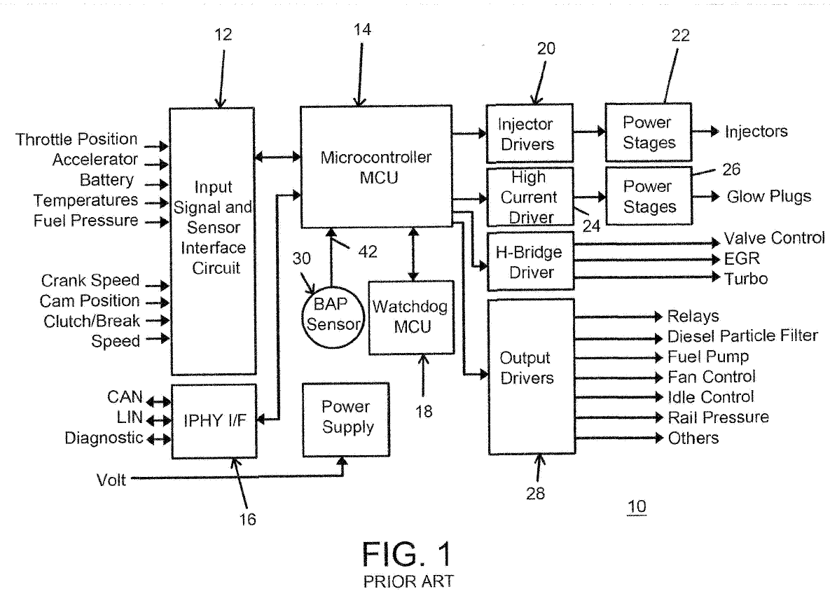

With respect to computerized Diesel engines, and referring to FIG. 1, a typical late model OBD-II diesel engine control system 10 is shown. More particularly, an input signal and sensor interface 12 receives inputs from a variety of engine sensors and controls, and conditions or otherwise configures the signals for input to a microprocessor 14.

A bidirectional bus between microprocessor 14 and PHY/IF 16 provides a configuration and factory interface port in order to access and change factory and manufacturer settings, provide software updates, etc. A watchdog MCU 18 monitors driver and truck performance during operation of the truck and engine, when the fuel tank caps are removed, and so forth. An output 20 to injector drivers 20 and 22 determine timing and duration of opening of the fuel injectors, with high current drivers 24 and 26 controlling operation of the glow plugs. Outputs from microprocessor 14 to an h-bridge driver control the exhaust gas recirculation valve, the waste gate of a turbopump for controlling boost, and other valves of the engine. Yet other outputs from microprocessor 14 are provided to output drivers 28 to control or activate various relays, the fuel pump, fuel pressure regulator and other devices.

Most relevant to the instant invention is a barometric pressure sensor switch, jumper plug or wire 30 that indicates to microprocessor 14 elevation of the engine above sea level. This input to microprocessor 14 allows the control program in microprocessor 14 to adjust at least injected fuel quantity for any throttle position, which in the case of a truck is determined by operator demand, and in some instances the fuel injection timing. As such, an amount of fuel injected into the cylinders is compensated or adjusted according to an altitude above sea level, or as noted above a selected altitude, at which the engine is operating so as to provide less fuel for any given throttle setting with higher altitude. Also as noted above, the settings compensated for higher altitude generally provide less injected fuel for any selected throttle position. However, and as noted above, such automatic compensation, in most cases does not adequately provide an optimum amount of injected fuel, but is rather is an estimate provided by the manufacturer that typically provides too much fuel for any given throttle setting. In addition, there is no compensation provided for a varying oxygen content of atmospheric gasses.

In one embodiment of the Invention, and for a computerized Diesel engine, typically in a modern truck or other vehicle, a control system for a diesel engine includes at least one fuel injection pump and one or more fuel-injected cylinders, and an input to an engine controller that indicates altitude and at least one throttle position sensor. The barometric pressure sensor that is typically connected to the engine controller and in fluid communication with the engine air supply, or the air surrounding the engine, is disconnected from the engine controller or otherwise disabled, and a module of the instant invention connected to the engine controller in its place. The module is mounted in a position easily accessible by the operator of the vehicle, such as in the cab of a truck, and allows the operator to make adjustments to the amount of injected fuel independent of the throttle position. In many instances, a predetermined adjustment may be made depending on extent of loading of the truck, as described above, although adjustments may also be made during operation of the truck, such as when going up long or steep inclines.

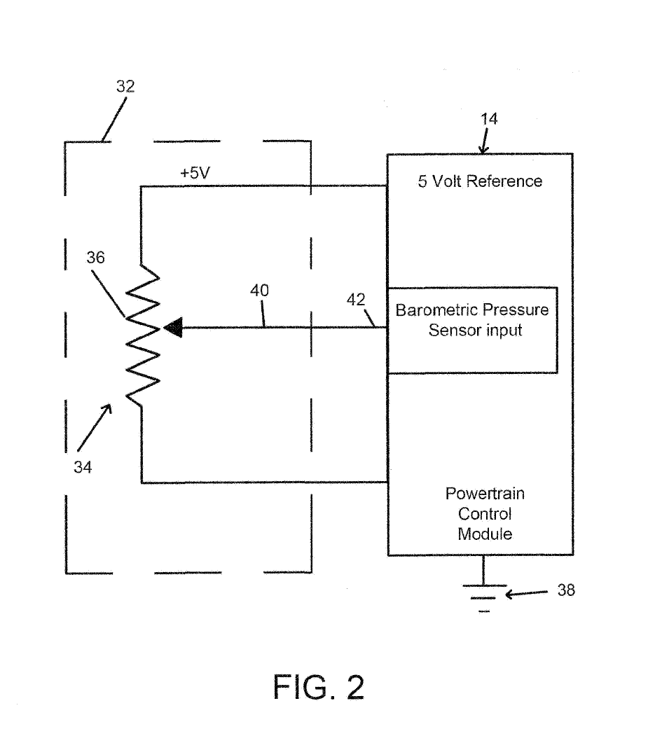

Referring to FIG. 2, a module 32, shown in dashed lines, is mounted as described near the operator of a computer-operated Diesel engine, such as in the cab of a truck. In module 32 is a potentiometer or rheostat 34, which functions as a voltage divider. A reference voltage, typically 5 volts, that otherwise would be provided to a barometric pressure sensor, switch, jumper or the like is connected to one side of the resistive element 36 thereof, with the other side of resistive element 36 connected to a ground 38 via engine computer 14. Wiper 40 of potentiometer or rheostat 34 is connected to the input 42 of engine controller 14 so as to provide a divided, variably selected voltage of less than 5 volts to input 42. Wiper 40 is also mechanically connected to a knob or lever on the exterior of module 32 as described to allow the operator to manually adjust the voltage applied to input 42 independent of the barometric pressure sensor 30. With this construction, the input to the engine controller that otherwise would be connected to a barometric pressure sensor or jumper setting to automatically provide a barometric pressure indication to the engine controller is now converted to a manual fuel adjustment under operator control. The engine controller interprets this manually provided input voltage as an altitude, and correspondingly reduces, or in some cases increases, the quantity of injected fuel corresponding to the altitude indicated by the voltage. In most computer controlled Diesel engines, 4.5 to 5 volts provided by wiper 40 to input 42 corresponds to operation at around 1,000 feet below sea level, or about 15.14 PSI, while a low voltage, such as 0 to 0.5 volts, corresponds to the highest altitude a truck can go, which in the United States may be approximately 14,000 feet. Available oxygen at 14,000 feet is 12.2% compared to 21% at sea level, meaning that an operator of a Diesel engine equipped in accordance with a manual engine control of the instant invention is able to reduce injected fuel quantity, for any given throttle position, by almost half, which is useful when an engine is idling for long periods of time, and increase an injected fuel quantity and increase a fuel quantity for any given throttle position by about 3%, which may be useful when going up long or steep inclines, travelling with very heavy loads or travelling in an area where available oxygen in the atmosphere is at a ratio less than about 21%. By providing this control to an operator, a Diesel engine will operate more efficiently and burn fuel cleaner with less emissions and particulates than otherwise would be the case with absolute, predetermined settings that do not take into account local conditions such as loading and the proportion of oxygen in the inducted air.

While use of a barometric pressure sensor input is disclosed, it should be apparent that any other input or combination of inputs to a Diesel engine controller may be used that trim or adjust injected fuel quantity for any given throttle position in accordance with local or instant conditions under which the engine is operating. Also, where the engine is only equipped with a jumper or jumper plug in an electronic engine controller that selects between over or under 10,000 feet, it has been found that Applicants method of FIG. 2 also works as well on these engines as an engine equipped with a barometric sensor. This is because engine controller software for Diesel engines is generally the same whether a jumper or barometric pressure sensor is used to indicate altitude, meaning that a variable voltage on input 42 can be used to vary a quantity of injected fuel for any given throttle position on virtually any engine with an electronic engine controller.

As noted above, for an older engine without an electronic engine controller, easily conceived mechanical arrangements may be used to mechanically adjust the fuel pump to provide an adjusted quantity of injected fuel for any given throttle position in accordance with the local or instant conditions, including the local proportion of oxygen content of the air. It is emphasized that the instant invention does not change the programming or the fuel map of an engine controller in a Diesel engine. As such, the engine operates within the parameters set by the engine manufacturer.

In accordance with the foregoing, and while the Invention has been described in terms of various specific embodiments, those skilled in the art will recognize that the Invention can be practiced with modification within the spirit and scope of the following appended claims, wherein

We claim:

1. A method for operating a Diesel engine comprising:
evaluating operation of the Diesel engine for a given load and any given throttle position,
adjusting quantity of injected fuel into cylinders of the Diesel engine for any throttle position while the Diesel engine is operating to improve operation of the Diesel engine,
maintaining an adjusted quantity of injected fuel for said any throttle setting, thereby maintaining an improved state of operation of the Diesel engine.

2. The method as set forth in claim 1 wherein said adjusting quantity of injected fuel further comprises providing an adjustment that is conveniently accessible to an operator of the Diesel engine while the Diesel engine is operating.

3. The method as set forth in claim 2 further comprising operating the Diesel engine in a truck.

4. The method as set forth in claim 3 further comprising locating the adjustment in a cab of the truck, thereby allowing a driver of the truck to adjust the quantity of injected fuel while driving the truck.

5. The method as set forth in claim 4 wherein said adjustment further comprises modifying a barometric pressure sensor input of a Diesel engine controller for the adjusting quantity of injected fuel into cylinders of the Diesel engine for said any throttle position.

6. The method as set forth in claim 4 wherein said adjustment further comprises providing varying voltages within a range of voltages to an altitude jumper input of a Diesel engine controller for the adjusting quantity of injected fuel into cylinders of the Diesel engine for said any throttle position.

7. A method for operating a Diesel engine having an electronic engine controller comprising:
evaluating operation of said Diesel engine for a given load and any given throttle position,
while said Diesel engine is operating, varying a voltage applied to an altitude input of said electronic engine controller independently of an actual altitude the engine is located in order to adjust a quantity of fuel injected into cylinders of said Diesel engine for any given throttle position to improve operation of said Diesel engine,
when operation of said Diesel engine is optimally improved, maintaining a selected voltage applied to said altitude input of said electronic engine controller.

8. The method of claim 7 further comprising changing said selected voltage as operating conditions of said Diesel engine change in order to maintain an optimally improved state of operation of said Diesel engine.

9. The method of claim 8 further comprising developing said voltage applied to said altitude input of said electronic engine controller using a manual control operated by an operator of said Diesel engine.

10. The method as set forth in claim 9 wherein said Diesel engine is in a vehicle, and mounting said manual control within convenient reach of a driver of said vehicle.

11. The method as set forth in claim 10 wherein said vehicle is a truck, with said manual control mounted in a cab of said truck.

12. The method as set forth in claim 11 further configuring said manual control as a clicking detent knob wherein each click of said clicking detent knob is representative of an increment of load.

13. A method for operating a Diesel engine having an electronic engine controller with at least one electrical input for receiving a voltage representative of altitude, said method comprising:
developing a voltage representative of optimal operation of said Diesel engine,
disconnecting said voltage representative of altitude from said electrical input for receiving a voltage representative of altitude,
applying said voltage representative of optimal operation of said Diesel engine to said electrical input for receiving a voltage representative of altitude, thereby optimizing operation of said Diesel engine.

14. The method as set forth in claim 13 further comprising changing said voltage representative of optimal operation of said Diesel engine as operating conditions of said Diesel engine change in order to maintain said optimal operation of said Diesel engine.

15. The method as set forth in claim 14 further comprising changing said voltage representative of optimal operation of said Diesel engine using a manual control.

16. The method of claim 15 wherein said Diesel engine is in a truck, and mounting said manual control in an operator's compartment of said truck within convenient reach of the operator while operating said truck.
